(19) United States
(12) Patent Application Publication
(10) Pub. No.: US 2004/0083547 A1
(43) Pub. Date: May 6, 2004

(54) Hand washing-device

(76) Inventor: Joel Mercier, Biot (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/149,415

(22) PCT Filed: Dec. 22, 2000
(86) PCT No.: PCT/FR00/03668

(30) Foreign Application Priority Data
Dec. 24, 1999 (FR) 99/16498

(51) Int. Cl. E03C 1/05; B08B 3/02

(52) U.S. Cl. 4/623; 134/56 R; 134/94.1; 134/95.3; 134/104.2; 134/113

(57) ABSTRACT

The invention concerns a sanitary device comprising:

a cleaning volume (32) defined by walls and open on one side (49);

means (38, 43) for detecting the presence of hands in said volume;

means (34, 36, 41) for projecting a fluid (39) onto hands present in the cleaning volume.

### FIELD OF THE INVENTION AND PRIOR ART

The invention relates to the field of hygiene, in particular hand hygiene.

It is applicable to public and private hospitals, to the agriculture and food field (stock farming, production, distribution, and shops), to canteens, for example on-board vehicles, or to local and private catering.

It is of particular application when running water connections for hand washing are not available, before and after any medical intervention or even before or after a production step.

Despite ever more rigorous standards of hygiene being applied, in particular in hospitals, many cases of nosocomial infections or infections due to hand-borne contamination are still being reported.

The hands are the principal means of transmitting the microorganisms that are responsible for infections. Hand flora originates from the human body and/or from contact with the environment and/or from contact with other persons and/or from infectious locations or airborne microbes or from microbes that are already present in a certain location.

There is thus a problem with obtaining devices that completely satisfy all hygiene requirements.

Known devices experience difficulties with detecting the passage of hands. That detection is not always effective, depending on the pigmentation of the hands, or whether they are covered with gloves (for example surgical gloves).

Further, such devices are sometimes activated at inopportune moments, for example by a television remote control in a patient's room.

Further, such devices are often provided with cleaning fluid containers that are sometimes substandard or which are difficult to handle, causing additional difficulties and spurious infections in particular.

Finally, such known devices are generally bulky and thus not conducive to mobile use or to multiple use in various locations.

### SUMMARY OF THE INVENTION

A sanitary device comprises:

a cleaning volume defined by walls and open on one side;

means for projecting a fluid into the cleaning volume;

emission means for emitting radiation or for emitting ultrasound into the cleaning volume;

reception means for receiving radiation or ultrasound reflected by the walls of the cleaning volume, said reception means emitting a signal in response to radiation or ultrasound dependent on the presence of hands in said volume; and

means for treating the signals emitted by the reception means, said treatment means controlling means for projecting a fluid so that said fluid is projected over said hands.

Ultrasound or sound waves can be used in place of radiation or electromagnetic waves.

The emission, reception and treatment means constitute detection means suitable for detecting the presence of hands inserted into said volume.

Detecting the presence of hands and cleaning the hands without the hands contacting the cleaning volume provides effective disinfection with no risk of transmission by hand-borne contamination.

Further, projecting fluid into the cleaning volume avoids projection outside the cleaning volume. Thus, there are no problems connected with any risk of flammability of a cleaning solution projected onto the hands.

The fluid is preferably contained in a removable pouch connected to the fluid projecting means by connection means that are also removable.

Preferably again, the pouch/connection assembly is disposable, thus avoiding re-using used pouches into which sources of contamination may have been introduced.

The means for projecting a fluid comprise, for example, a spray nozzle provided with a coaxial jet, itself provided with grooves to cause the fluid to swirl while it is being projected into the cleaning volume.

Preferably, the fluid projection means comprise a peristaltic pump. With such a pump system, a fluid projection pipe can readily be introduced into the pump and can be withdrawn from the pump, again allowing a safer device to be produced. The fluid projection pipe can then be disposed of as soon as the pouch containing the cleaning fluid is empty.

The cleaning volume is preferably a volume with no roughness. It is preferably formed inside a shell, itself in one piece. This avoids roughness, grooves, and recesses that constitute favorite spots for dust to be deposited and for microbial flora and other contamination and infection vectors to accumulate.

The device is controlled by electronic means, in particular electronic means for initiating projection of fluid when hands are detected in the cleaning volume.

Preferably, when the detection means use electromagnetic waves, the detection means can operate, at regular intervals, to detect variation in the intensity of the reflected radiation compared with reference intensity for said reflected radiation.

Means may also be provided for detecting variation in the reference intensity of the reflected radiation. This avoids any sensitivity to variation or drift in the conditions imposed by the environment, i.e., by the interior of the cleaning volume and by the walls defining it.

The detection means preferably operate synchronously, meaning that any spurious signals outside the time windows can be ignored.

The radiation is preferably emitted into the detection volume in the form of coded pulses. This avoids spurious or untimely activation of the sanitary device of the invention by external electronic means, for example a television remote control.

Finally, display means can be provided, in particular means that tell a user whose hands have been introduced into the cleaning volume that it is time to withdraw the hands from the cleaning volume. This guarantees that a user will not withdraw his/her hands until a dose of cleaning fluid has been fully and effectively projected.

The invention also provides a connection system for a fluid pouch, comprising a connection pipe and a jet tip. Further, such a system can be connected to a syringe and/or needle and/or plunger system for connection to the pouch or receptacle containing the fluid.

### BRIEF DESCRIPTION OF THE FIGURES

The characteristics and advantages of the invention become clearer from the following description. This description relates to non-limiting examples given by way of explanation and made with reference to the accompanying drawings in which:

FIGS. 1A to 1C are general views of a device in accordance with the invention showing a variety of embodiments:

FIG. 2 is a block diagram for a device of the invention;

FIG. 3 shows an embodiment of a pouch of fluid and its connection means in accordance with the invention;

FIG. 4 shows a projection nozzle for a device of the invention;

FIG. 5 is a timing diagram of the pulses emitted by an emitter and the detection windows;

FIG. 6 shows a pulse reflected by the wall of a device of the invention;

FIGS. 7A to 7C are timing diagrams of an example of the operation of a device of the invention;

FIG. 8A is a general block diagram of an electronic control device of a device of the invention;

FIG. 8B is a detailed circuit diagram of an electronic control device for a device of the invention;

FIG. 9 is an example of a display device for a device of the invention.

### DETAILED DESCRIPTION OF EMBODIMENTS OF THE INVENTION

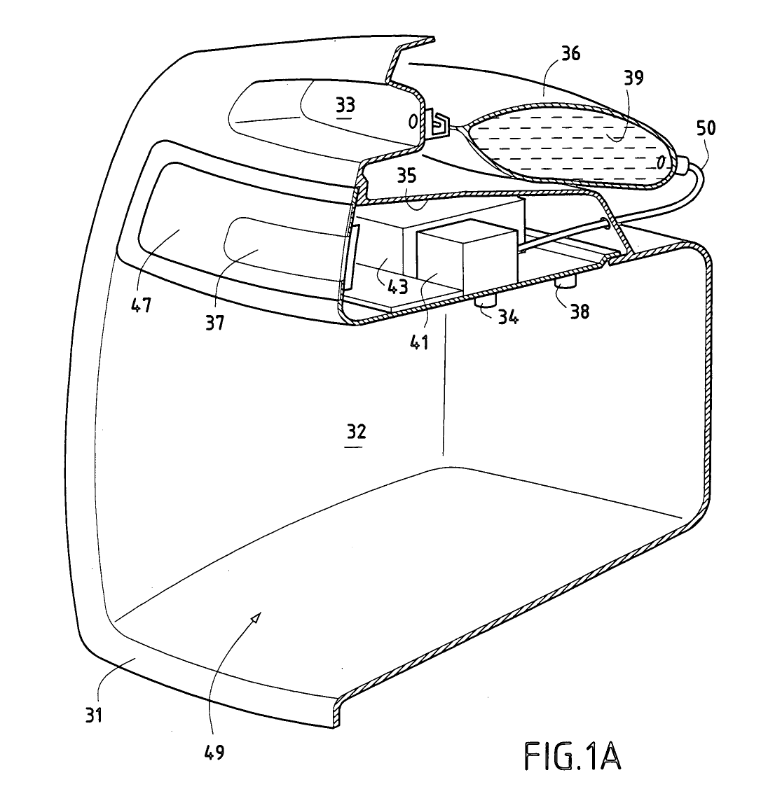

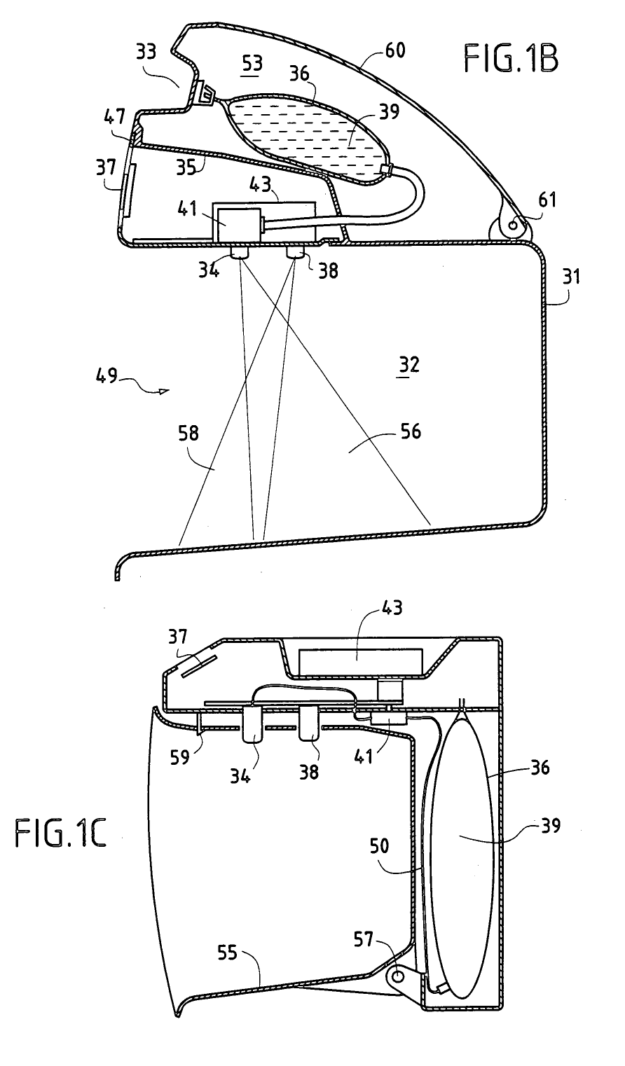

An embodiment of the invention is shown in FIGS. 1A and 1B. In this figure, reference numeral 32 designates a cleaning volume defined by five walls and open on one side. Opening 49, located at the front of the device, is of a size sufficient to allow both hands of a person to be introduced.

A receptacle 36 located above the cleaning volume 32 contains a cleaning fluid 39. However, said receptacle can be located below or to one side of the cleaning volume.

Means 38, various examples of which are given below, serve to detect the presence of hands in said volume.

Reference numeral 34 designates means for projecting a cleaning fluid onto the hands present in volume 32, after the presence of the hands has been detected inside the volume 32 by detection means 38.

The operation of the device and in particular detecting the presence of hands in the volume 32 and projecting the fluid as a result of such detection, is controlled by the electronics 43 or control block, which is preferably contained in a compartment 35. The electronics 43 is isolated from means 36 that contain the cleaning fluid and from the inside of the volume 32.

A pump, or pump unit 41, which can be controlled by the electronics 43, ensures that a quantity of fluid is removed from receptacle 36 and is projected into the volume 32 via spray means 34. Said pump has a pump head containing a flexible tubular component in which the fluid can be entrained, and a pump housing comprising an electric motor intended to compress said tubular component.

A front panel 47 has a liquid crystal display type display device 37. Preferably, such a device has no fixing screws or depressions or projections and no possibility of becoming incrusted in dust or micro-germs or any other substance of a contaminating nature.

A cover 60 hinged about an axis 61 located on the rear of the device forms a compartment 53 in its closed position, which compartment contains the receptacle 36 for the cleaning fluid.

The device can also be provided with a recess 33 to allow it to be carried. It is not necessary to attach the device to another object itself intended for carrying. This avoids mechanical contact with other parts, which may be dirty.

Further, the inside of the volume 32 preferably has no angles, corners, recesses, or roughness, as they constitute favorite locations for depositing and retaining dust and other particles that can be deleterious to good hygiene.

Preferably again, the volume 32 forms part of a shell 31 formed from a single piece in which the front panel 47 that supports display means 37 is embedded, and which has no roughness that might retain dust or other particles. The shell 31 can be produced from injection-molded plastic, ABS or the like, or produced from sheet plastic or stainless steel. Injection molded parts and stainless steel parts can optionally be combined.

In a variation, the shell 31 is made up from a plurality of parts forming a single-piece unit to avoid even the slightest possibility of incrustation with micro-dust, micro-germs or other contaminating substances.

Inside the volume 32, the spray means 34 can spray a cleaning fluid into a spray cone or zone 56.

Similarly, the detection means 36 can detect the presence of hands inside the hand detection zone or cone 58 that overlaps with the spray zone 56, at least in part.

FIG. 1C shows a further embodiment of a device in accordance with the invention. Reference numerals identical to those shown in FIGS. 1A and 1B designate elements that are identical or that correspond to those in FIGS. 1A and 1B. The receptacle or pouch 36 is mounted at the rear of the device, in a compartment provided for this purpose. As before, the fluid is projected or sprayed from the top of the cleaning compartment via means 34. The means 43 are mounted in a compartment located at the top of the device.

The cleaning compartment is hinged about an axis 57. It is held at the top by means 59, for example clips.

In the embodiments described above, access to the fluid receptacle 39 is easy, which allows the receptacle to be changed easily when it is empty.

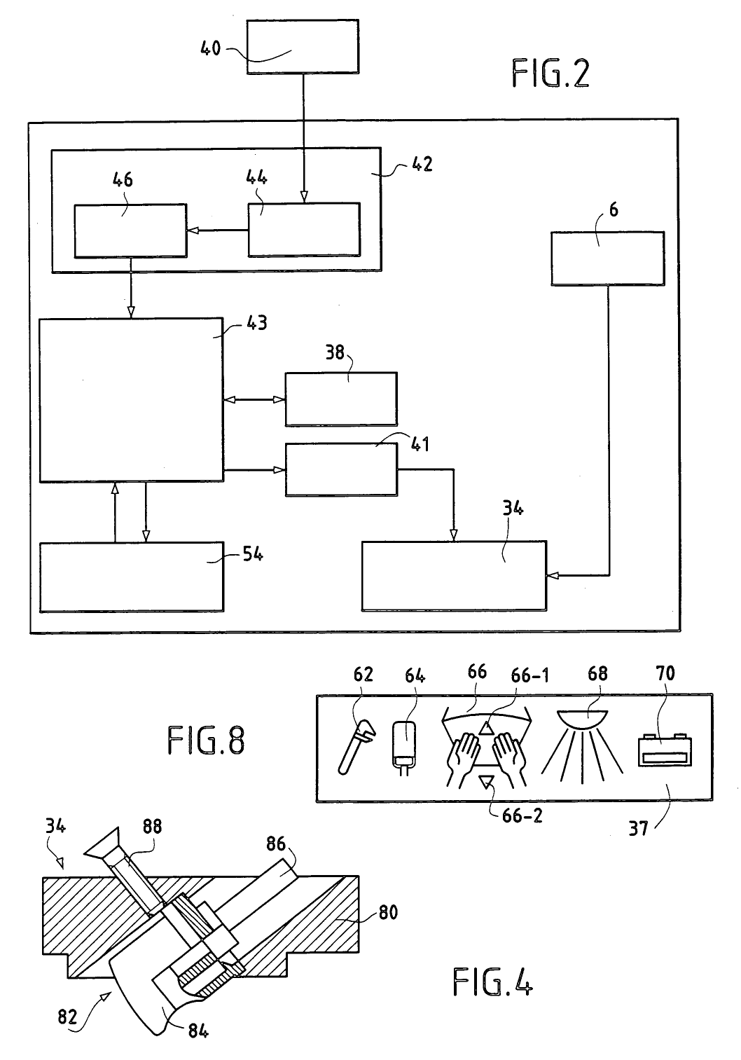

FIG. 2 is a diagram showing the operation of the device.

The electronics or control block 43 receives signals from means 38 for detecting the presence of an object or hands inside the volume 32.

Preferably, the same control block 43 controls the operation of the pump 41, itself connected to the means 34 for projecting fluid into the volume 32. This fluid comes from the receptacle 36 in which the cleaning fluid is stored.

Optionally, the control block 43 also controls user interface means 54, in particular the display screen 37 of FIGS. 1A and 1B.

The control block is powered by means 40, 42. In the example shown in FIG. 2, mains power is connected to means 44 for charging a battery 46, which in turn power the control block 43.

The receptacle 36 used to contain the cleaning fluid 39 is preferably a plastics medical type pouch. The use of disposable PET or shrinkable HDPE pouches can be envisaged. Clearly, any other type of material that can provide the required properties would be suitable. During various successive uses, the pouch is gradually emptied of its fluid but no external particle and no external atmosphere can penetrate into the pouch.

The fluid used is preferably a hydroalcoholic solution and the pouch contains 0.250 liters to 2 liters. After being spraying onto the hands, a thin protective film remains on the skin for a certain period.

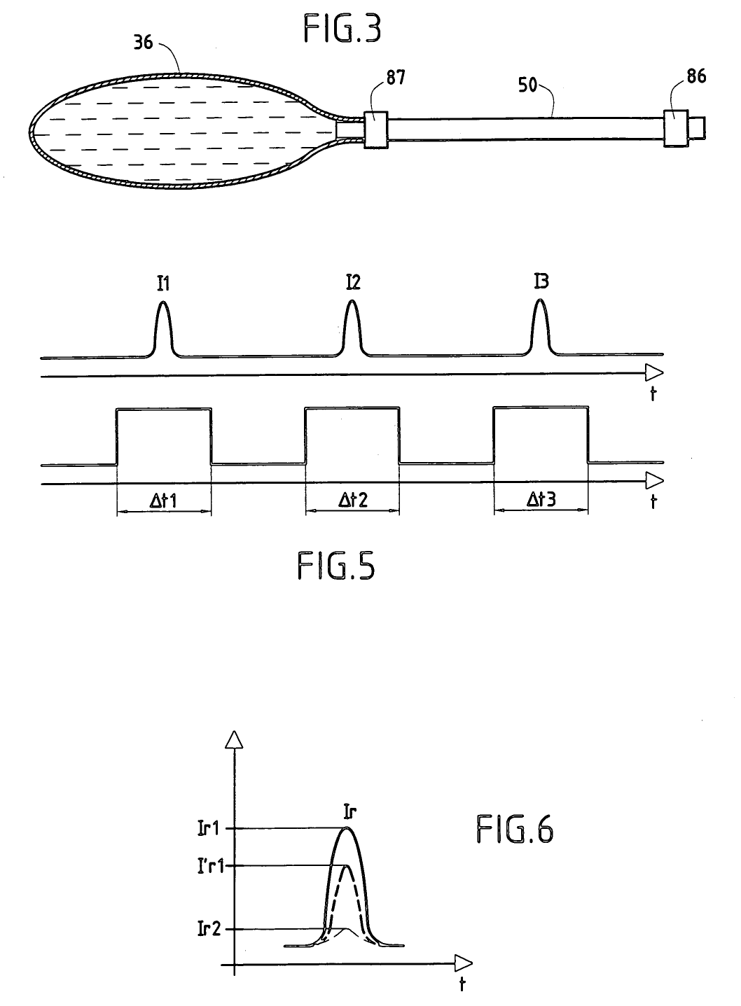

As shown in FIG. 3, the outlet from the pouch 36 is provided with a connection tube 50 having a jet tip 86 mounted at its end. This jet tip projects a quantity of fluid into the volume 32.

The tube/tip assembly constitutes a connection system that can be detached and separated from the pouch 36. It can be combined with needle and/or syringe type and/or plunger type means for producing a connection with the pouch or receptacle containing the fluid.

The pump 41 is preferably a peristaltic pump. Said pump is capable of projecting fractions of disinfecting fluid in the range 1 milliliter (ml) to 3 ml. Clearly, the pump can be regulated to adjust the volume of fluid delivered. The tube 50 is then introduced into the peristaltic pump 41, and then the tip 86 is mounted onto the end of the tube.

Finally, as shown in FIG. 4, the tip 86 is introduced into an orifice of a support 80 for the spray means 34. A jet nozzle 84 distributes the fluid into the volume 32. The conical nozzle is at a predetermined angle to obtain a suitable spray angle. The jet 84 is preferably provided with grooves that can cause the fluid to swirl while it is being projected into the volume 32. A screw 88 with a ground tip allows the flow rate and pressure of the projected fluid to be regulated.

The means 50, 86 for connecting the pouch to the spray means 34 can be separated from each other and from the pouch 36.

The pump block 41 can be selected so as to be regularly exchanged, for example each time the pouch 36 is replaced. This avoids wear in the mechanism for projecting the fluid into the volume 32. In this manner, the efficacy of the cleaning operations is constant. Preferably, the pump head is removable and thus it can be changed with the pouch/connection means assembly using a new disposable kit comprising a new pump head and a new pouch/connection means assembly to accomplish optimum sanitary security. The pump head comprises a brass contact which has to be removed before installing the disposable kit.

The tube 50 can be produced from Santoprene or silicone, for example.

Means 38 for detecting an object or hands in the volume 32 can, for example, comprise a capacitative sensor, for proximity detection.

Advantageously, the detection means are constituted by an ultrasound emitter and receiver and treatment means controlling the fluid-projection means.

Preferably, however, detection is carried out using electromagnetic radiation, more particularly infrared electromagnetic radiation.

“Passive infrared” type detection can be disturbed by external heat sources such as a convector or a radiator, or by external electromagnetic radiation, which initiates projection of the fluid in an undesirable manner.

For this reason, it is preferable to use an “active” type infrared detection sensor. Using said sensor, it is possible to detect the presence of hands at a distance of up to about 20 centimeters (cm).

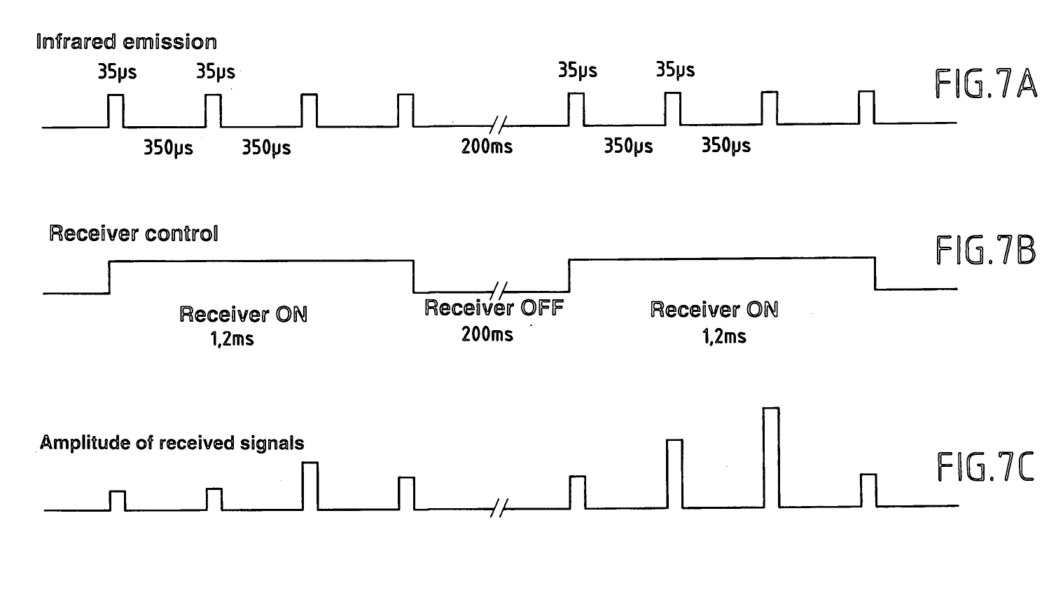

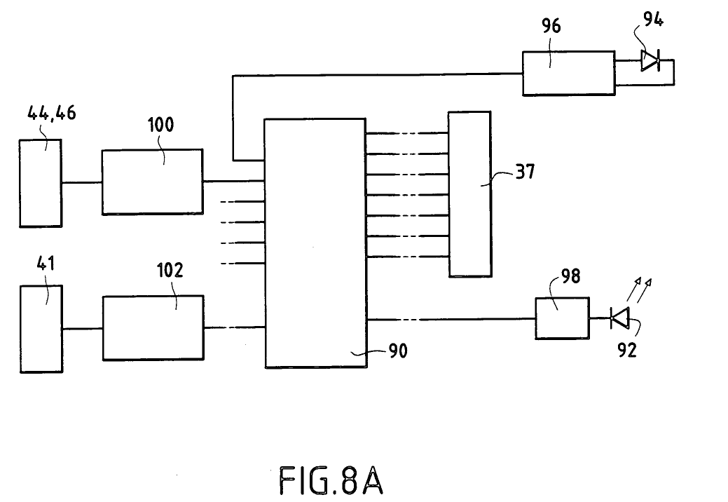

For this type of detection, an infrared emitter and receiver are used. The infrared emission is controlled by the electronics 43. In one embodiment, infrared pulses are emitted into the volume 32 at regular intervals. As an example, pulses of 100 microsecond duration are emitted once every 100 milliseconds. In a further embodiment, N pulses (N>1, for example: N=2 or 3 or 4 or 5) are emitted in bursts, the bursts themselves being emitted at regular intervals. An example of this mode of emission is given below with reference to FIGS. 7A to 7C.

The detector preferably operates on the principle of synchronous detection. The presence of the emitted signal is then monitored during a certain time window. Any other signal outside this window cannot disturb the operation of the device.

More precisely, as shown in FIG. 5, the emitter regularly emits pulses Ii, 12, 13., while detection of the presence of a signal reflected by the surfaces of volume 32 occurs during intervals Δt1, Δt2, Δt3. The same principle applies for pulses emitted in packets.

When there is no object present in the volume 32, a pulse Ii emitted by the infrared emitter is reflected from the walls defining the volume, and the detector then detects a reflected pulse of a certain amplitude within a time window Δt1.

The presence of an object or hands inside the volume 32 disturbs the reflection of the radiation in the direction of the reflector. A variation in the intensity of the reflected radiation indicates the presence of hands inside the volume 32 when this variation exceeds a certain threshold. Fluid projection can then be initiated.

The signals received by the detector are treated by the electronic means of block 43.

The signals emitted by the emitter can also be coded. Only proper reception of this code will start the pump. This code can, for example, be emitted cyclically and sufficiently rapidly for disinfection to be initiated in less than 0.2 to 0.3 seconds.

Said coding of the signals emitted by the emitter can render the device insensitive to the use of a television remote control, for example, or of a tape recorder in its environment. This type of environment is often encountered in the rooms of patients in hospitals or clinics.

FIG. 6 shows the change with time of an infrared pulse reflected by the walls of volume 32. In the absence of any objects or hands inside the volume, the reflected beam has a maximum intensity Ir1.

When hands are introduced into the volume 32, the intensity of the reflected beam varies and reaches a value Ir2. The variation Ir1-Ir2 is interpreted by the electronics as the presence of hands in the volume 32 and a quantity of fluid is then projected to start cleaning.

In the example given, this variation is a reduction. However, depending on the reflectivity of the walls and the pigmentation in the hands, the reflectivity may be modified in the direction of an increase or of a reduction.

It may be that over time, the reflective characteristics of the surfaces of the walls defining the volume 32 may change. As an example, the color of the surfaces of the walls may alter over time or a certain substance (and in particular a substance contained in the disinfecting fluid 39 which is regularly projected into the volume 32) can slowly be deposited on the walls of volume 32. All of these factors can modify the reflective characteristics of these walls. This has the result that, with an empty volume 32, the intensity of the reflected beam may gradually diminish from Ir1 to I′r1. The maximum intensity or reference intensity with respect to which the presence of hands is detected is then no longer Ir1 but I′r1. In other words, the variation Ir2-I′r1 is the variation that initiates projection of a dose of cleaning fluid, and no longer the variation Ir1-Ir2.

To overcome this problem, the electronics is programmed to carry out regular measurements of the variations in the amplitude of the beam reflected by the walls of volume 32. Preferably, measurements of the intensity of the reflected beam are made over a certain period, for example over several minutes, to determine whether the reflection intensity varies when the volume 32 is empty. It is then possible to identify any slow change in the reference medium with respect to which the presence of hands in the volume 32 is to be detected.

In one embodiment, the pulses are emitted in groups over periodic intervals with a predetermined period T2. Within each group, the pulses (of number N>1, for example N=3 or 4 or 5 or more) are separated from each other by an interval T1, also predetermined. The mean intensity of reflected radiation is then determined, also over periodic intervals with a predetermined period, for example with period T2. The control block calculates the mean value of the amplitude of the pulses received in response to each group of pulses emitted. Spray initiation occurs if the variation in the mean value exceeds an index value.

The reception means preferably operate only over these same periodic intervals, which can save energy supplied by the power supply.

FIGS. 7A to 7C are timing diagrams for an example of this embodiment. They show the infrared pulses emitted (FIG. 7A), the receiver operation intervals (FIG. 7B) and the reflected pulses received by the device receiver (FIG. 7C).

In the example shown, the pulses are emitted in groups of 4, each pulse having a width of 35 microseconds and being separated from other pulses in the same group by intervals T1=350 microseconds (FIG. 7A). The pulse packets are separated by intervals T2=200 ms.

In this example, the receiver is on during periods of 1.2 milliseconds (ms) and is off during T2=200 ms, between two consecutive periods of operation (FIG. 7B).

The received signals are shown in FIG. 7C. The control block calculates the mean value of the amplitude of 4 pulses received in response to each group of 4 emitted pulses. Initiation of spraying occurs if the variation in the mean value exceeds an index value.

This mode of operation or coding, and in particular as described in connection with FIGS. 7A to 7C, avoids a disturbance from spurious pulses such as those resulting, for example, from operating a television remote control.

Advantageously, the means for detecting the presence of hands in the cleaning volume are constituted by an ultrasound device.

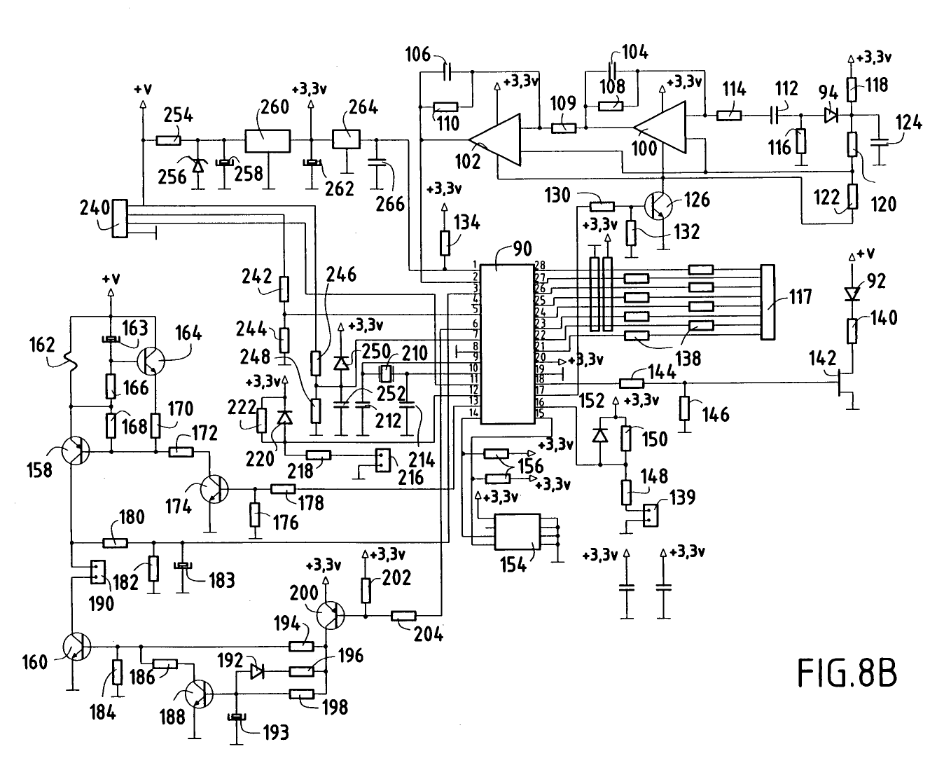

FIG. 8A shows the electronic circuit 43 for controlling the pump 41.

In this figure, reference numeral 90 designates a microcontroller. As an example, this can be a PIC 16 LC 72-04/SO microcontroller from Microchip.

This microcontroller can control the display on display means 37.

The detection means 8 comprise an emitting diode 92 and a receiving diode 94. The microcontroller 90 thus controls the emission of pulses via the diode 92 via the associated circuit 98.

Further, after amplification, the microcontroller receives signals produced by the diode 94. Said signals are amplified and filtered by an amplification and filtering circuit. The signals are then treated and analyzed in the manner explained above, the microcontroller 90 being programmed for this purpose.

The motor for pump 41 is also controlled by the microcontroller 90 via a circuit 102 for monitoring the speed and controlling the pump motor.

A circuit 100 serves to detect the presence of a battery charger 46, to control charging of the batteries, and to regulate the voltage supplied to the device as a whole.

FIG. 8B shows a detailed embodiment of the electronic device 43. The component values indicated thereon are by way of example, as are the bias voltages indicated on the figure.

Reference numerals 37, 41, 90, 92, 94 designate the same elements as shown in FIG. 8A.

In this device, the circuit 90 controls infrared detection and the motor and provides the display for screen 37.

A power supply supervisor constituted by components 134, 264, 266 is associated with said circuit to ensure proper initiation. Reference numeral 264 designates a controller; reference numeral 266 designates a capacitor of about 100 nanofarads (nF) and reference numeral 134 indicates a resistor of about 100 kilohms (kΩ).

In order not to exceed the specifications of the microcontroller 90, protective elements are provided (resistors 218 (about 100 kΩ), 222 (about 47 kΩ), 246 (about 470 kΩ) and 248 (about 470 kΩ), diodes 220 and 250, and capacitor 252 (about 100 nF)).

The control circuit for the emitting diode comprises two resistors 144, 146, of 390 kΩ and 100 kΩ respectively, which constitute a voltage divider connected to the gate of a field effect transistor 142, FET. The source and drain for the transistor are respectively connected to earth and to a resistor 140 of 22 kΩ, to which emitting diode 92 is itself connected.

Pin 18 of microcontroller 90 generates pulses, said signals then being amplified by transistor 142, to generate a current in emitting diode 92. That current is limited by resistor 140; for example, it is fixed at 200 milliamps (mA).

An 8-way connector 117 connects display 37 to microcontroller 90. The control circuit for display 37 essentially comprises 1 kΩ resistors 138.

The circuit 96 for amplifying and filtering the signals received by the diode 94 for receiving reflected pulses is constituted as follows.

A capacitor 112 (2.2 nF) and a resistor 114 (100 kΩ) are connected in series and connected to the inverting input of an amplifier 100. The amplifier is biased firstly by a 3.3 V voltage source and secondly by a circuit connected to an output of the microcontroller 90 and which essentially comprises a first resistor 130 (10 kΩ) and a second resistor 132 (100 kΩ), constituting a voltage divider to which the base of a transistor 126 is connected.

A feedback loop essentially comprises a capacitor 104 (4.7 pF) and a resistor 108 (470 kΩ) connected in parallel.

The outlet from the first amplifier 100 is connected to a resistor 109 (100 kΩ) and to the inverting input of a second amplifier 102, biased in the same manner as the first, and having a feedback loop comprising components 106, 110 identical to components 104, 108.

The amplifiers 100, 102 with their associated components 104, 106, 108, 109, 110, 112, 114, 116 (47 kΩ), 118 (1 kΩ), 120 (47 kΩ), 122 (10 kΩ), 124 (100 nF) amplify the current from the receiving diode 94 and convert it into a voltage that can be used directly by pin 2 of the microcontroller 90.

A two-terminal connector 139 ensures manual control of the system. Said connector is connected to the microcontroller via two resistors 148 (100 kΩ) and 150 (47 kΩ). A diode 152 is connected in parallel with the resistor 150. Elements 148, 150, 152 are protective elements that ensure that the specifications of the microcontroller 90 are not exceeded.

A circuit 154 ensures re-initialization of the microcontroller 90 and storage of permanently retained data.

The resistance of the resistors 156 is 47 kΩ.

A two-terminal connector 190 is intended to be connected to the motor of the pump 41. Two transistors 158, 160 mounted as shown in FIG. 8B are connected to this connector.

The transistor 158 is connected to a thermal fuse 162. With these elements, transistors 164 and 174 and resistors 166, 168 (about 4.7 kΩ), 170, 176 (100 kΩ) and 178 (10 kΩ) constitute a circuit for analyzing the current to the pump motor. Components 163, 164, 166 do not need to be provided.

The voltage of the motor is controlled by resistors 180 (24 kΩ) and 182 (12 kΩ).

In addition to the transistor 160, the motor control circuit comprises, resistors 184, 186 (respectively 47 kΩ and 10 kΩ), a transistor 188, a diode 192, resistors 194, 196 and 198 (3.3 kΩ, 1 kΩ and 370 kΩ respectively), a transistor 200 and resistors 202 (100 kΩ) and 204 (10 kΩ).

The motor is controlled by two pins of the microcontroller 90.

The pin 6 of the microcontroller generates a continuous command for 2.5 seconds, active in the “0” state. This command is amplified by transistors 160 and 200. Components 184, 194, 202, 204 ensure proper blocking and saturation of these transistors.

The elements 186, 188, 193, 192, 196 and 198 serve to limit the maximum running time of the motor in the event of the microcontroller failing.

Pin 13 of the microcontroller generates a signal with a variable duty ratio; this signal is amplified by transistors 158 and 174.

The image of the motor voltage is obtained via 180, 182, 183 then sent to pin 3 of 90.

Analogue signals present on this pin are internally converted into digital signals by the microcontroller 90.

A comparison between these signals and a reference voltage, also within the microcontroller 90, allows the duty ratio of the signals on the pin 13 of the microcontroller to be adjusted.

This operation servo-controls the speed of the motor independently of battery voltage.

Components 163, 166, 170 and 164 can limit the current if the motor jams.

An oscillator 210 supplies the microcontroller 90 with clock signals. As shown in FIG. 7B, this oscillator 210 is connected between two capacitors 212, 214 each of 56 pF. Its operating frequency is 800 kHz, for example.

A two-terminal connector 216 detects the presence or absence of a pouch 36 of fluid. Two circuits associated with this connector comprise the resistor 218 (100 kΩ), the diode 220 and the 47 kΩ resistor 222.

The presence of a charger can be detected and the battery charge can be controlled via a 4-terminal connector 240.

The image of the battery voltage is sent to a pin of the microcontroller which also has an analogue-to-digital converter.

The voltage on said pin is measured by the microcontroller. As soon as this voltage falls below a fixed value (for example 3.075 volts for a battery voltage of 6.15 volts), the “battery” icon 70 on screen 17 illuminates.

When this voltage drops below a fixed value (for example 2.975 volts, i.e. 5.95 volts of battery voltage), the microcontroller blocks the operation of the entire spray system and causes the “battery” icon on the screen to flash.

The system resumes its operational status when the battery voltage once again exceeds a certain value, for example 6.35 volts.

The “charge command” signal is generated by pin 11 and the “charger present” signal is generated via the pin 5.

Since the voltage in the battery is not constant, provision is made for adjusting the voltage used to power the control circuits.

The voltage selected is 3.3 volts, for example; it is provided via controller 260, and capacitors 258, 262.

The resistor 254 and the diode 256 protect the components mentioned above against any voltage surges.

When the microcontroller is switched on, infrared signals are emitted by diode 92. Said signals are reflected by the lower surface of the casing, and a portion is returned to the infrared receiver. They are amplified, and then the result is forwarded to pin 2 of the microcontroller 90.

This pin also has an analogue-to-digital converter.

The converted value is stored in the microcontroller.

This procedure can be termed “calibration”.

When introducing hands into the infrared beam, the degree of reflection changes and causes a variation in the numerical value of the received signal.

The microcontroller constantly calculates the difference between the received value and that memorized it during calibration.

If that difference exceeds a given amount, the motor is run for the spraying time.

During spraying, no infrared signals are emitted.

When the spraying period is over, the microcontroller again generates infrared signals.

A new cycle of hand detection can then take place. One condition for this can be that the measured value equals that memorized during calibration.

The display means 37, e.g. made up of light emitting diodes (LEDs), may comprise a set of symbols or icons, 62-70, as shown in FIG. 9.

In this figure, the symbol 62 represents a display which indicates to the user that repair is necessary.

The symbol 64 indicates that the level of fluid 39 in the receptacle 36 has reached a minimum value which requires early replacement of the receptacle 36 with a full volume of cleaning fluid, or refilling of the receptacle.

Two arrows 66-1, 66-2 on the symbol 66 indicate that the user's hands can be introduced into the device (display 66-1), or that the hands can be withdrawn once a period that is sufficient to ensure complete cleaning has elapsed (display of arrow 66-2).

The symbol 68 indicates to a user that fluid is being projected.

Finally, the battery symbol 70 indicates to a user that the energy available from the battery 46 is below a certain threshold value.

The features of a particular embodiment of a device of the invention are given below.

Power Supply

The mains power supply is constituted by a commercially available DC adapter.

It provides unregulated DC at 0.3 amps (A) and at 12 volts (V).

The battery block is composed of 5 NIMH (nickel-metal hydride) cells of 1.35 volts each with a maximum capacity of 1.3 ampere-hours. In this way, the system can operate for about 2000 spray operations without recharging the batteries. 5 or 6 volt batteries could also be used.

Battery charging is controlled by an electronic device. Charging is complete in less than 4 hours. After this time, a maintenance current is provided to prevent damage to the batteries.

Control Block 43

This carries out several functions:

generating, receiving and analyzing signals from the infrared detector;

generating pump control signals, said signals determining:

a) the length of time the pump operates in order to distribute a quantity of fluid (2 ml);

b) servo-control for the speed of the motor;

controlling the user interface:

c) displaying different icons on the LCD screen;

d) taking into account information from the push button to suspend operations and go into maintenance mode;

monitoring the battery voltage:

e) when the available energy in the battery drops below 20%, the battery symbol illuminates. The operation of the system remains the same;

f) when the available energy drops below 10%, the battery symbol flashes.

The system stops operating. The system becomes operational again after the batteries have been recharged.

The various data (number of sprays, changing pouch) are stored in the memory even when the battery has no more energy.

Pumping

The pump is a peristaltic pump.

It is composed of a DC motor and a miniature removable cassette.

This choice means that the entire fluid distribution section can be changed without having to change the motor, and in particular the pump head which has a titanium or brass safety tip, thus preventing any leaks or flow of fluid.

The overall characteristics of this assembly are:

| a) with a Santoprene tube: | | |
|---|---|---|
| supply voltage | 6 | volts |
| current | 290 | mA |
| flow rate | 48 | ml/minute |
| maximum service pressure | 1.5 | bar |
| b) with a silicone tube: | | |
| supply voltage | 5 | volts |
| current | 290 | mA |
| flow rate | 48 | ml/minute |
| maximum service pressure | 1.5 | bar |

Spraying is ensured by a commercially available diffuser which can produce a spray cone of 500 at a pressure of 1.5 bar (tolerable limit for the pump).

However, the pressure can be reduced and the spray angle can be diminished while keeping the flow rate the same.

The characteristics of the pump and diffuser determine the spray time.

For 2 ml of fluid, the spray time is:

(60 seconds/48 ml)×2 ml=2.5 seconds

Infrared Detection

This is accomplished with an emitting diode and a high efficiency receiving diode to minimize consumption.

Pulses are emitted every 250 milliseconds and last a few microseconds. This can further reduce consumption without deleteriously affecting reaction time when hands are introduced.

The detection principle is of the synchronous type.

The emission and reception lobes are determined as a function of the position of the hands and of the spray cone.

Two user interfaces are present:

1. the viewing screen, a non-multiplexed LCD that can produce strong contrast and broad viewing angle;

2. a push button that is accessible to the user which can place the device in a maintenance mode or can clean the inside of the casing. Pressing the button once more returns the system to its normal mode.

A flexible medical type pouch is used to store the fluid. The pouch contains 0.65 liters.

System Discharge Time

The system discharge time (time until the “low battery” symbol illuminates on the LCD) can be estimated as follows:

energy available to battery: 80% of 1.3 ampere-hours (at 6 volts), i.e., 1004 mA;

consumption of all electronic boards: a constant 300 PA;

consumption on each spray operation: 290 mA, over 2.5 seconds;

current consumed per day on spraying (ccds):

((100 uses/day)×290 mA×2.5 seconds/3600)=20.2 mA/day

current per day for electronic boards:

24 hours×300 μA=7.2 mA (cp);

total current consumed per day=(cp)+(ccds)=20.2+7.2 mA=27.4 mA/day

the operating time can thus be estimated to be 1004/27.4, i.e., more than 36 days at 100 uses/day.

When the device is used more intensively, the discharge time can be estimated as follows:

for 500 uses/day: discharge time of about 9 days;

for 1000 uses/day: discharge time of about 4% days.

The device of the invention can be used in sensitive areas (resuscitation or cardiology or orthopaedic wards, or corridors, or access chambers to very clean rooms or patient's rooms) and on trolleys. It can produce a very high level of sanitary security.

The invention is also applicable in the following environments:

hospitals, clinics, retirement homes;

medical establishments, in particular doctors, kinesitherapists, dentists, gynecologists, podologists, pediatricians, dermatologists;

pharmaceutical laboratories and medical analytical laboratories;

home care professions;

ambulances and rescue vehicles;

beauty institutes.

The device of the invention can be permanently attached to a wall or it can be clipped to a wall, or it may be transportable. Further, it can operate from the mains with voltages of 100 volts to 250 volts at a frequency of 50 Hz or 60 Hz. However, it can operate from its own batteries, and include automatic or semiautomatic devices for standard disinfection fluids.

For safety reasons, the shape of the transportable version of the device of the invention is such that it can be carried in one hand. Further, it includes an hinged rear with a push lock that can be secured with a key.

1/ A sanitary device comprising:
a cleaning volume (32) defined by walls and open on one side (49);
means (34, 36, 41) for projecting a fluid (39) into the cleaning volume;
emission means (38) for emitting radiation or for emitting ultrasound into the cleaning volume;
reception means for receiving radiation or ultrasound reflected by the walls of the cleaning volume, said reception means emitting a signal in response to radiation or ultrasound dependent on the presence of hands in said volume; and
means (43) for treating the signals emitted by the reception means, said treatment means controlling said means for projecting a fluid so that said fluid is projected over said hands.

2/ A device according to claim 1, wherein the fluid (39) is contained in a removable pouch (36) connected to said means (34, 36, 43) for projecting a fluid (39) via connecting means.

3/ A device according to claim 2, wherein the removable pouch (36) is contained in a compartment located on the top or rear of the device.

4/ A device according to one of claims 1 to 3, wherein the means (34, 36, 43) for projecting a fluid (39) into the cleaning volume comprise a spray nozzle.

5/ A device according to claim 4, wherein the spray nozzle comprises a coaxial jet.

6/ A device according to claim 5, wherein the jet is provided with grooves for causing the fluid to swirl while it is being projected into the cleaning volume.

7/ A device according to any one of claims 1 to 6, wherein the means for projecting fluid comprise a peristaltic pump.

8/ A device according to any preceding claim, wherein the cleaning volume (32) is a volume with no roughness.

9/ A device according to any preceding claim, wherein the cleaning volume (32) forms part of a shell (31) formed from a single piece.

10/ A device according to any one of claims 1 to 9, further comprising electronic means (43) for initiating projection of fluid (39) when hands are detected in the cleaning volume (32).

11/ A device according to any one of claims 1 to 10, wherein the radiation emitted into the cleaning volume is electromagnetic radiation.

12/ A device according to claim 11, wherein the radiation emitted into the cleaning volume is infrared electromagnetic radiation.

13/ A device according to claim 11 or claim 12, further comprising means for detecting, at regular intervals, any variation in the intensity of the reflected radiation compared with a reference intensity for said reflected radiation.

14/ A device according to claim 13, wherein the intensity of the reflected radiation is detected as a mean over periodic intervals with a predetermined period.

15/ A device according to claim 13 or claim 14, wherein the reception means detect reflected pulses over periodic intervals with a predetermined period.

16/ A device according to one of claims 13 to 15, further comprising means for detecting any variation in the reference intensity of the reflected radiation.

17/ A device according to claim 16, wherein a variation in the reference intensity of the reflected radiation is detected as a mean over a given period.

18/ A device according to one of claims 1 to 17, wherein the emission means, reception means and signal treatment means operate synchronously.

19/ A device according to one of claims 1 to 18, wherein the emission means emit coded pulses.

20/ A device according to one of claims 1 to 19, comprising display means indicating to a user who has introduced his/her hands into the cleaning volume a request (66-2) for withdrawing said hands from the cleaning volume after a certain cleaning period.

21/ A device according to one of claims 1 to 20, wherein the means for projecting or spraying a fluid comprise a pump and a pump motor.

22/ A device according to claim 21, wherein the device further comprises means (163, 166, 170) for limiting the current supplied to the motor if the latter ceases to operate.

23/ A device according to claim 21 or claim 22, further comprising means (164, 174, 166, 170, 178) for analyzing a current from the pump motor.

24/ A device according to one of claims 21 to 23, further comprising a battery and means (158, 174, 180, 182, 183) for controlling the motor speed independently of the voltage of the battery.

25/ A device according to any one of claims 1 to 23, further comprising means for supplying a voltage to the device, and means (90) for stopping the means (34, 36, 43) for projecting a fluid from operating when the power supply voltage drops below a given threshold value.

26/ A connecting system for a pouch of fluid (36), comprising a connection tube (50) and a jet tip (34).

27/ A system according to claim 25, connected to a syringe and/or a needle and/or a plunger to produce a connection with a pouch (36) or a receptacle.
